(19) United States
(12) Patent Application Publication
(10) Pub. No.: US 2009/0311998 A1
(43) Pub. Date: Dec. 17, 2009

(54) METHOD AND SYSTEM FOR STORING A CONTACT DETAIL IN A COMMUNICATION DEVICE

(75) Inventor: DWAYNE ADAMSKI, SYCAMORE, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/137,858

(22) Filed: Jun. 12, 2008

(51) Int. Cl. H04M 15/00

(52) U.S. Cl. 455/415

(57) ABSTRACT

A method and system for storing a contact detail in a communication device is provided. The device receives Dual-Tone Multi-Frequency (DTMF) signals from another device during a communication session with the other device. The received DTMF signals correspond to the contact detail entered at the other device. The received DTMF signals are decoded at the device to obtain the contact detail. Thereafter, the decoded contact detail is then stored in a list in the device. The device user may have the option to accept or reject the contact detail and where to store the contact detail.

### TECHNICAL FIELD

The present invention relates in general to the field of communication devices, and more specifically, to a method and system for storing a contact detail in a communication device.

### BACKGROUND

Communication devices are increasingly important tools for transmitting and receiving audio or video information. In particular, the use of mobile communication devices, such as cellular phones, smart phones, and personal digital assistants (PDAs), has exploded in popularity. Typically, each mobile device through which a user transmits and receives audio communications has a particular phone number that is exclusive to it. When a user of one particular device wishes to connect to another device, the phone number of the other device is dialed or a shortcut is used to initiate the communication session. This shortcut can be, for example, selecting a phone number from a list of contacts, recently initiated, or recently received calls that are stored in the device.

After the connection has been established and the communication session initiated, one of the users (hereinafter referred to as the user) may desire a phone number or other contact detail (such name or address) of another party from the other user. Generally, the user desiring the contact detail manually records the desired information, e.g., by writing it down on paper during the session. After the session has ended, the contact detail can then be saved in the device by the user manually storing the information in the device.

This method works well, for example, if the user's hands are free or if the desired recording implements (e.g., pen and paper) are available. However, mobile devices are often used in neither of these situations. Furthermore, in certain situations in which mobile devices are used, it is dangerous for the user to search for recording implements and then manually write down the information. For example, the user may employ the device while operating a vehicle. Although the user may pull the vehicle over at a safe point, stop the vehicle, and then record the information, this is relatively inconvenient.

The other user may also transmit the contact detail in a text message to the user after the session has ended. This method incurs additional time and expense to both users. Further, the contact detail may not be available to the user desiring the contact detail for some time if the delivery of the message is delayed.

In light of the above, a method and system for storing a contact detail in a communication device during a communication session is desirable.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an embodiment of communication devices in communication with one another;

FIG. 2 illustrates an embodiment of the front of a communication device;

FIG. 3 shows a first portion of a flow diagram for a method for storing a contact detail in a communication device according to one embodiment;

FIG. 4 show a second portion of the flow diagram of FIG. 3; and

FIG. 5 illustrates an embodiment of circuitry in a communication device.

Skilled artisans will appreciate that elements in the figures are illustrated for simplicity and clarity and have not necessarily been drawn to scale. For example, the dimensions of some of the elements in the figures may be exaggerated, relative to other elements, to help in improving understanding of the various embodiments.

### DETAILED DESCRIPTION

Before describing in detail the particular method and system for storing a contact detail in a communication device in accordance with various embodiments, it should be noted that the apparatus components have been represented where appropriate by conventional symbols in the drawings. Only those specific details that are pertinent for an understanding of the embodiments are shown so as not to obscure the disclosure with details that will be readily apparent to those with ordinary skill in the art.

In this document, the terms ‘comprises,’ ‘comprising’, or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by ‘comprises . . . a’ does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

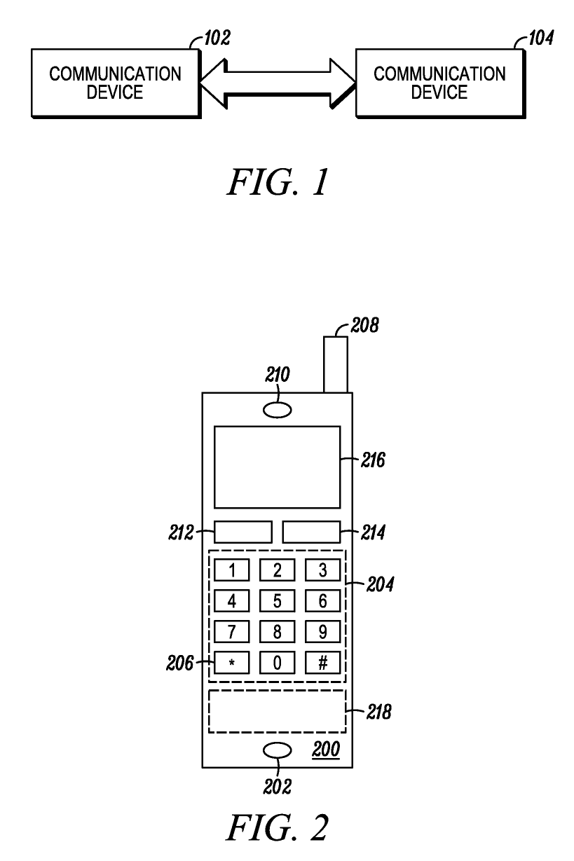

FIG. 1 illustrates a first communication device 102 (hereinafter referred to as a first device) in communication with a second communication device 104 (hereinafter referred to as a second device). Examples of the first and second devices 102 and 104 include, but are not limited to, mobile phones, fixed-line phones, smart phones, laptop and other computers, and Personal Digital Assistants (PDAs). Intermediaries between the first and second devices 102 and 104, such as base stations, service providers, external controllers, and other wired or wireless connection components, et al., are known but have been omitted for clarity.

To initiate a communication session between the first and second devices 102 and 104, the user of the first device 102 enters the contact number of the second device 104 on the first device 102 and a communication session is initiated. The contact number can be entered, for example, by manually pressing alpha-numeric buttons (not shown) on the first device 102 until all of the numbers forming the contact number of the second device 104 are entered, by manually selecting the contact number of the second device 104 from a list of stored contact information, received or placed calls, or by voice activation of the name associated with the second device 104.

A typical mobile device 200 is shown in FIG. 2. In this embodiment, the mobile device 200 includes a microphone 202 through which a user provides audio signals to the mobile device 200, an alpha-numeric keypad 204 containing keys 206 for entering information, an antenna 208 for transmission and reception, a speaker 210 that broadcasts audio signals for the user of the device 200, soft keys 212 and 214 (whose function varies depending on the mode of the mobile device 200), a display 216 that provides visual information for a user, and, optionally, a touch panel 218. Other mechanical elements such as specialized keys, buttons, dials (e.g., for channel selection), camera elements, antennas, ports, etc. may be present, but are not shown. The mobile device 200 shown may be, for example, a cell phone such as a bar-type cell phone, flip-type cell phone, or slide-type cell phone, a push-to-talk (PTT) phone, or a PDA.

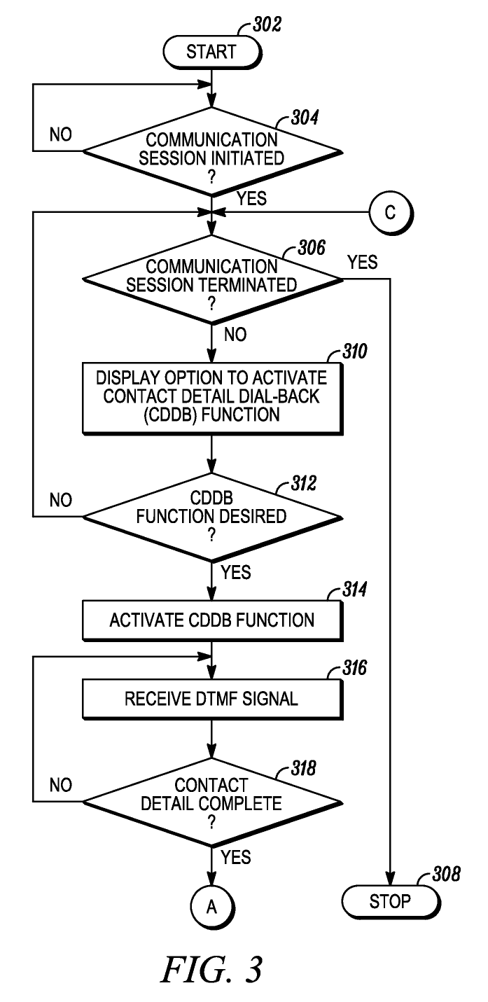

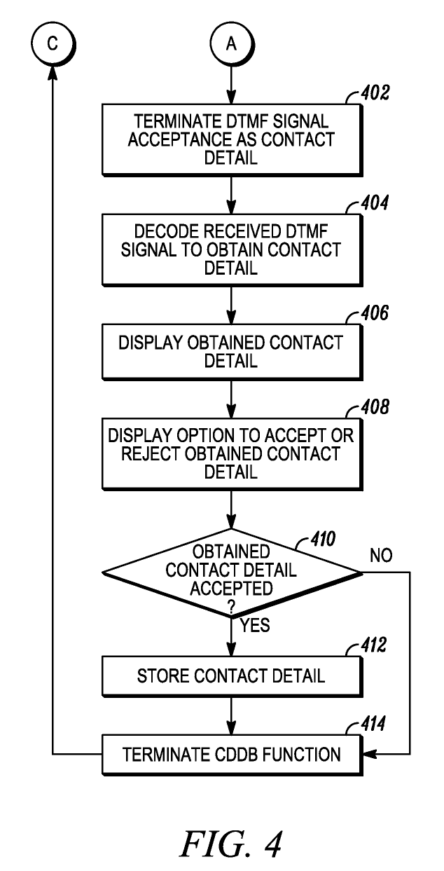

FIGS. 3 and 4 show a flow diagram of a method for storing a contact detail in a communication device such as the first device 102. More specifically, FIG. 3 shows a first portion of the flow diagram for the method for storing a contact detail in the first device 102 and FIG. 4 shows the second portion. As above, the contact detail can be, for example, a contact number (e.g., telephone, fax, or pager number), a name, an address, etc.

At step 302, the method for storing the contact detail in the first device 102 is initiated. At step 304, the first device 102 determines whether a communication session has been initiated between the first device 102 and the second device 104. This has been described more fully above in reference to FIG. 1.

At step 306, the first device 102 determines whether the communication session has been terminated (either by the first or second devices 102, 104 or externally such as by an external controller or due to signal loss). If the communication session has ended, then at step 308 the method terminates. At step 310, an option to initiate a contact detail dial-back (CDDB) feature is displayed on the display screen of the first device 102. Step 310 is performed after it is determined at step 306 that the communication session has not ended. The displayed option can be, for example, a message on the display 216 that states, ‘Press # to activate the CDDB function,’ ‘activate CDDB’ by pressing one of the soft keys 212, 214, or a centralized ‘CDDB’ and ‘Yes’ above one of the soft keys 212, 214. Another example of the displayed option can be, ‘Press 1 to activate the CDDB function, or press 3 to continue the communication session without activating the CDDB function.’ Other displays are, of course, possible.

The CDDB function is a user-activated feature in the first device 102. In other words, the CDDB function is activated when the user of the first device 102, e.g., manually presses a button on the keypad of the first device 102. The CDDB function is activated in the first device 102 when the user of the first device 102 wants to receive a contact detail from another communication device that is engaged in a communication session with the first device 102. At step 312, the first device 102 determines whether the mechanism to activate the CDDB function has been actuated (e.g., the particular key has been actuated). If the mechanism has not been actuated, then the communication session continues and the process returns to step 310. As above, the CDDB function can be activated in the first device 102 by pressing a soft key 212, 214 or the ‘#’ key on the keypad of the device 102. In the latter case, the first device 102 can be configured such that the CDDB function is activated whenever the first device 102 is engaged in a communication session and the user of the first device 102 presses the key ‘#’ on it when the option to activate the CDDB function is displayed. Although not shown, an additional input can be used to permit the option to be presented on the display 216 prior to the option being displayed. Thus, such a step would occur in the process prior to step 310 and would permit other functionality of the key ‘#’ to be active rather than the CDDB function.

At step 314, the CDDB is activated by software in the processor in the first device 102 once the mechanism is actuated. Although not shown, a request for confirmation of activation of the CDDB function may be displayed along with the appropriate key to press and only after the confirmation key actuated and detected does the software activate the CDDB function.

After the CDDB function is activated at step 314, a Dual-Tone Multi-Frequency (DTMF) signal is transmitted by the second device 104. At step 316, the transmitted DTMF signal is received by the first device 102. The DTMF signal received at the first device 102 corresponds to the contact detail manually entered at the second device 104. This DTMF signal is temporarily stored.

DTMF signals are generated when keys on the keypad of a communication device are actuated. For example, DTMF signals are generated when the keys 206 on the alpha-numeric keypad 204 of the mobile device 200 are actuated. When actuated, each key of the communication device generates a different DTMF signal. The DTMF signal comprises two tones of specific frequencies; one corresponding to high frequency (1209 Hz-1633 Hz) and one to low frequency (697 Hz-941 Hz). Multiple tones are generated to ensure that when the communication device is being used, the user's voice does not imitate any of the tones corresponding to the keys on the device. The tone frequencies are selected such that harmonics and intermodulation products do not interfere (i.e., no frequency is a multiple of another, the difference between or sum of any two frequencies does not equal any of the frequencies). The high frequencies may be the same volume or up to 3 dB louder than the low frequencies. In general, the minimum tone duration is at least 70 msec, although in some countries and applications DTMF receivers are able to reliably detect DTMF tones as short as 45 ms.

At step 318, the first device 102 determines whether the contact detail has been completed. If it is determined at step 318 that the contact detail has not been completed, then the process returns to step 316 and additional received DTMF signals are included with the contact detail already received.

To indicate that the contact detail is complete, a termination command may be transmitted by the second device 104. This termination command can be, for example, a DTMF signal corresponding to the ‘*’ key on the second device 104. When this termination command is received by the first device 102, at step 402, software in the first device 102 automatically terminates acceptance of the DTMF signal as part of the contact detail that has been received. In other words, when the termination command is received by the first device 102, it automatically disables the CDDB feature. Thus, after the termination command is received by the first device 102, further DTMF signals received by the first device 102 are ignored until the CDDB function is again activated. This eliminates potential errors in the received contact detail when an alpha-numeric key on the second device 104 is accidentally pressed after the completed contact detail has been transmitted to the first device 102.

At step 404, the received DTMF signal is decoded at the first device 102 to obtain the contact detail entered into the second device 104. For example, if telephone number XXXYYYZZZZ is entered at the second device 104, and the number is received by the first device 102 in the form of DTMF signals, the received DTMF signals are combined and decoded to obtain the number XXXYYYZZZZ at step 404.

At step 406, the contact detail (e.g., phone number) is displayed on the display 216 of the first device 102. In addition to the contact detail being displayed, a first option to accept and a second option to reject the obtained contact detail is displayed on the display 216 of the first device 102 at step 408. For example, text can be displayed that states, “Press 1 to accept the contact number or press 0 to reject the contact number.” In this case, the keys corresponding to the digits ‘1’ and ‘0’ are provided to the user of the communication device 102 to either accept or reject the obtained contact detail. The keys ‘1’ and ‘0’ can be pre-configured (at the factory, at the store, or by the user, but in any case prior to step 408) such that when ‘1’ is pressed, the obtained contact detail is accepted, and when ‘0’ is pressed the contact detail is rejected. Of course, other text describing the options and other keys (such as the # and * keys) may be used. In another example, text such as, “Accept?” and ‘Reject’ may be displayed over the appropriate soft keys 212, 214 and the appropriate action taken depending on the soft key 212, 214 actuated.

Either both options that correspond to the acceptance and rejection of the obtained contact detail may be displayed on the first device 102 or a single option that corresponds to the acceptance or rejection of the obtained contact detail may be displayed. For example, text can be displayed on the first device 102 that says, ‘Press 1 to accept the obtained contact number.’ In this case, if the key corresponding to the digit ‘1’ is actuated the obtained contact number, the contact detail is accepted. If the user presses any other key on the keypad of the first device 102, the obtained contact detail is rejected. Alternatively, the text displayed on the first device 102 can be, for example, “Press 1 to reject the obtained contact number.” In this case, the obtained number is rejected if the user presses the key ‘1’ and it is accepted if the user presses any other key on the keypad of the first device 102. In another example, text such as, “Accept?” or ‘Reject?’ may be displayed over one of the soft keys 212, 214 and the appropriate action taken depending on whether the soft key 212, 214 is actuated.

The first device 102 then determines whether the obtained contact number has been accepted (or equivalently rejected) at step 410.

Although not shown, once the first device 102 determines that the contact detail has been accepted or rejected at step 410, then an option to confirm the acceptance or rejection may be displayed on first device 102. For example, if the user presses the rejection button, say the key ‘0’ on the keypad of the first device 102, then text may be displayed on the display of the first device 102 that states, “Are you sure you want to reject the contact detail? If you are, press 1, otherwise press 0.” In this case, the keys ‘1’ and ‘0’ are provided to either confirm the rejection or accept the obtained contact detail. If the user presses ‘1,’ the obtained contact detail is rejected, and if the user presses ‘0,’ it is accepted.

If the user of the first device 102 chooses to reject the obtained number (e.g., the number is incorrect), the CDDB function is terminated at step 414 and the process returns to step 306. If, however, the user chooses to accept the obtained number (e.g., the obtained number is correct), the obtained contact detail is stored in the first device 102 at step 412.

In one embodiment, the obtained contact detail is a telephone or a mobile phone number. This number may be stored in memory of the first device 102. For example, the received telephone number may be saved in a ‘Received Call List,’ in a “Dialed Call List,” or in a list of contacts in the first device 102. After the received number is stored, the CDDB function is terminated at step 414 and the process returns to step 306.

In another embodiment, display of the contact detail (step 406) and/or the option(s) may be eliminated (steps 408, 410). By eliminating some or all of these, manual operation of the device by the user is minimized. The device may wait indefinitely until the various inputs are provided (e.g., different options, confirmations entered or the DTMF signals terminated) or a timer internal to the device may be used to limit the amount of time for response after the request is initially requested. The timer can limit the time from seconds (e.g., 15, 30, or 45) to several minutes (e.g., 1 or 2). If a response is not entered in the allotted time period, the device can default to rejection and the process continue from the point of default or return to step 306 in FIG. 3. Before and/or after the allotted time runs out, an audible or visual warning may be provided by the device. After any selection or timeout, the display may return to a default display.

As described above, the buttons or keys used to activate, accept, reject, or confirm may be the same or different, merely being actuated at different times.

The order of at least some of the various steps of the method shown in FIGS. 3 and 4 may be changed. For example, the order of steps 306 and 310 can be exchanged and the above-mentioned timer and warning steps inserted between the appropriate steps. Other modifications are also possible. The various options for selection may be displayed at steps other than those shown in FIGS. 3 and 4. Further, although not shown in FIGS. 3 and 4, the display of the various options provided in these figures as well as otherwise described can be terminated at any desired step shown or between steps shown.

For convenience, the method has been described with reference to a telephone number, although it will be understood that the method or a modified version thereof may be used with the other types of contact details. For example, the user of the second device 104 enters a contact address, which is received, decoded, and then stored in a contact database of the first device 102 for later retrieval.

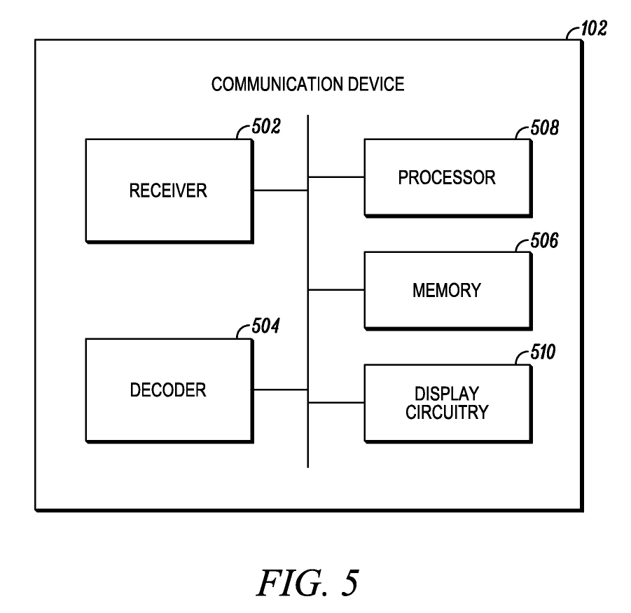

FIG. 5 illustrates a block diagram of one embodiment of internal circuitry of the first device 102. As shown, the first device 102 includes a receiver 502, a decoder 504, a memory 506, a processor 508, and display circuitry 510 among other components that are not shown for convenience. The receiver 502 receives signals, including audio signals and DTMF signals, from other communication devices. The decoder 504 decodes the received DTMF signals. The memory 506 temporarily stores the received DTMF signals and/or the decoded signals. The display circuitry 510 controls the text displayed on the display 216. The processor 508 controls the components shown and may be combined with one or more of the components (such as the decoder 504).

Although only two devices are shown in communication in FIG. 1, it is possible for multiple devices to be in communication. If multiple devices are in communication, the CDDB function can be activated on one or more of the devices while another of the devices simultaneously provides the contact detail to each of the devices in which the CDDB function is active. In this case, the processes on each of the devices run in parallel and each of the devices receiving the DTMF signals can independently accept or reject the contact detail.

In other embodiments, one or more additional inputs could permit the user of the receiving device to select where the contact detail is stored. For example, after acceptance of the contact detail, the receiving device may display a list of memory locations (e.g., recently received calls, contacts) to store the contact detail along with the corresponding alpha-numeric key to select each location. When the user actuates a particular key corresponding to one of the locations, the contact detail is then stored in the selected location.

Note that user inputs other than keys can be actuated for the various functions described above. For example, scroll or jog wheels or touchpads, if they are present, may be used. Similarly, the placement of the inputs may be anywhere on the device, and not merely on the front face of the device as shown in FIG. 2. For example, the input could be on the side face of the device.

Various embodiments, as described above, provide a method and system for storing a contact detail in a communication device. A user of a communication device is able to store a contact detail in the device during a communication session without having to write down or memorize the contact detail and later manually add the contact detail to the device. The user of the communication device can employ the CDDB feature if the user is otherwise occupied, for example, driving or jogging or if writing implements are not easily or quickly available. Further, transfer of the contact detail through additional communication sessions between two communicating devices may be avoided. For example, typically after the communication session is ended one user may supply a contact detail to another user by sending a text message to the second communication device. However, the method described herein enables the contact detail to be transferred during the communication session while other communication occurs. This eliminates the cost and effort required for text messaging the contact detail. Also, as the received contact detail is automatically saved in the device additional effort by the user is avoided.

It will be appreciated that the embodiments of the invention described herein may comprise one or more conventional processors and unique stored program instructions that control the one or more processors, to implement, in conjunction with certain non-processor circuits, some, most or all of the functions of the embodiments of the invention described herein. The non-processor circuits may include, but are not limited to, a radio receiver, a radio transmitter, signal drivers, clock circuits, power source circuits and user input devices. Some or all the functions can be implemented by a state machine that has no stored program instructions, or in one or more application-specific integrated circuits (ASICs), in which each function or some combinations of certain of the functions are implemented as custom logic. Of course, a combination of these approaches can also be used. Thus, means for these functions have been described herein. In those situations where the functions of the embodiments of the invention can be implemented by using a processor and stored program instructions, it will be appreciated that a means for implementing such functions is the medium that stores the stored program instructions, be it magnetic storage or a signal conveying a file. Further, it is expected that one with ordinary skill, notwithstanding possibly significant effort and many design choices motivated by, for example, available time, current technology and economic considerations, when guided by the concepts and principles disclosed herein, will be readily capable of generating such stored program instructions and ICs with minimal experimentation.

In the foregoing specification, the invention and its benefits and advantages have been described with reference to specific embodiments. However, one with ordinary skill in the art will appreciate that various modifications and changes can be made, without departing from the scope of the present invention, as set forth in the claims. Accordingly, the specification and the figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all the equivalents of those claims, as issued.

The Abstract of the disclosure is provided to comply with 37 C.F.R. §1.72(b), which requires an abstract that will enable a reader to quickly ascertain the nature of the technical disclosure. It is submitted with the understanding that it will not be used to interpret or limit the scope or meaning of the claims. In addition, it can be seen in the foregoing Detailed Description that various features are grouped together in a single embodiment, for the purpose of streamlining the disclosure. This method of disclosure should not be interpreted as reflecting an intention that the claimed embodiments require more features than are expressly recited in each claim. On the contrary, as the following claims reflect, the inventive subject matter lies in less than all the features of a single disclosed embodiment. Thus, the following claims are hereby incorporated into the Detailed Description, with each claim standing on its own as a separately claimed subject matter.

What is claimed is:

1. A method for storing a contact detail in a communication device, the method comprising the device:
receiving Dual-Tone Multi-Frequency (DTMF) signals during a communication session, wherein the DTMF signals correspond to the contact detail;
decoding the received DTMF signals to obtain the contact detail; and
storing the contact detail in the communication device.

2. The method as recited in claim 1, wherein the contact detail is a telephone number and storing the contact detail comprises saving the telephone number in a recent call list of the communication device.

3. The method as recited in claim 1, further comprising providing a user-activated contact detail dial-back feature in the communication device activated by pressing a first button on the communication device.

4. The method as recited in claim 3, further comprising providing a user-activated rejection mechanism for rejecting the received contact detail when the received DTMF signals correspond to an incorrect contact detail, the received contact detail rejected by pressing the first button.

5. The method as recited in claim 3, further comprising providing a user-activated rejection mechanism for rejecting the received contact detail when the received DTMF signals correspond to an incorrect contact detail, the received contact detail rejected by pressing a second button on the communication device, the first and second buttons being different.

6. The method as recited in claim 1, further comprising, prior to storing or rejecting the contact detail:
displaying, at the same time, a first option to store the received contact detail and a second option to reject the received contact detail;
providing buttons respectively to accept the first or second option; and
storing the received contact detail only if the first option has been selected.

7. The method as recited in claim 6, further comprising:
displaying an option to confirm rejection of the received contact detail if the contact detail has been rejected; and
providing a button to accept the option to confirm rejection of the received contact detail.

8. The method as recited in claim 1, further comprising, prior to storing the contact detail:
displaying a single option either to store or to reject the received contact detail; and
providing a button to accept the option.

9. The method as recited in claim 1, further comprising providing a termination mechanism that, when received from a remote communication device, automatically disables the contact detail dial-back feature, the termination mechanism initiated by a DTMF signal corresponding to a termination command.

10. A method for storing a contact number in a first communication device during a communication session with a second communication device, the method comprising:
enabling activation of a user-activated contact number dial-back feature in the first communication device;
receiving Dual-Tone Multi-Frequency (DTMF) signals at the first communication device after the contact number dial-back feature is activated, wherein the DTMF signals correspond to the contact number dialed at the second communication device;
decoding the received DTMF signals to obtain the contact number; and
storing the contact number in the first communication device.

11. The method as recited in claim 10, further comprising enabling an activation button on the first communication device such that pressing the activation button activates the contact number dial-back feature.

12. The method as recited in claim 11, further comprising enabling a rejection feature of the first communication device such that pressing a rejection button on the first communication device rejects an incorrect contact number entered using the second communication device.

13. The method as recited in claim 12, further comprising automatically disabling the contact number dial-back feature after the received DTMF signals have been terminated.

14. The method as recited in claim 12, wherein the activation button and the rejection button are different buttons.

15. The method as recited in claim 12, wherein the activation button and the rejection button are the same button.

16. The method as recited in claim 10, further comprising, prior to storing or rejecting the contact number:
displaying at least one of an option to store the contact number or an option to reject the contact number;
providing buttons corresponding to the displayed option; and
storing the contact number if:
the option to store the contact number, if present, has been selected, or
the option to reject the contact number, if present, has not been selected.

17. A communication device comprising:
a receiver for receiving Dual-Tone Multi-Frequency (DTMF) signals during a communication session, wherein the DTMF signals correspond to a contact detail;
a decoder for decoding the received DTMF signals to obtain the contact detail; and
a memory for storing the contact detail in a call list of the communication device.

18. The communication device as recited in claim 17, further comprising a first button for activating a contact detail dial-back feature in the communication device.

19. The communication device as recited in claim 17, further comprising a second button for rejecting the contact detail when the received DTMF signals correspond to an incorrect contact detail, wherein the first and second buttons are the same button.

20. The communication device as recited in claim 17, further comprising a second button for rejecting the contact detail when the received DTMF signals correspond to an incorrect contact detail, wherein the first and second buttons are different buttons.
